(19) United States
(12) Patent Application Publication
(10) Pub. No.: US 2025/0314356 A1
(43) Pub. Date: Oct. 9, 2025

(54) PRESSURE VESSEL

(71) Applicants: HYUNDAI MOTOR COMPANY, Seoul (KR); KIA CORPORATION, Seoul (KR); LOTTE CHEMICAL CORPORATION, Seoul (KR)

(72) Inventors: Dong Sun Lee, Hwaseong-si (KR); Jae Han Chung, Hwaseong-si (KR); Gwi Nam Song, Hwaseong-si (KR); In Bo Kang, Uiwang-si (KR); Young Koan Ko, Uiwang-si (KR); Min Hyeok Hwang, Uiwang-si (KR); Jong Ik Byun, Uiwang-si (KR)

(73) Assignees: HYUNDAI MOTOR COMPANY, Seoul (KR); KIA CORPORATION, Seoul (KR); LOTTE CHEMICAL CORPORATION, Seoul (KR)

(21) Appl. No.: 18/896,538

(22) Filed: Sep. 25, 2024

(30) Foreign Application Priority Data
Apr. 8, 2024 (KR) 10-2024-0047549

(51) Int. Cl. F17C 13/06

(52) U.S. Cl. CPC F17C 13/06; F17C 2201/0109; F17C 2203/0604; F17C 2203/0619; F17C 2205/0305; F17C 2221/012

(57) ABSTRACT

A pressure vessel includes a liner configured to store a target fluid, a boss provided at an end of the liner, and a liner neck part. The liner neck part includes a first neck portion bent from and connected to the end of the liner and configured to define a first sealing surface provided to contact the boss, a second neck portion bent from and connected to an end of the first neck portion and configured to define a second sealing surface provided to contact the boss, and a third neck portion bent from and connected to an end of the second neck portion and configured to define a third sealing surface provided to contact the boss. The pressure vessel also includes a pressing part configured to press the first neck portion, the second neck portion, and the third neck portion against the boss.

### CROSS-REFERENCE TO RELATED APPLICATION

This application claims priority to and the benefit of Korean Patent Application No. 10-2024-0047549 filed in the Korean Intellectual Property Office on Apr. 8, 2024, the entire contents of which are incorporated herein by reference.

### TECHNICAL FIELD

The present disclosure relates to a pressure vessel, and more particularly, to a pressure vessel capable of ensuring sealing performance and improving safety and reliability.

### BACKGROUND ART

A hydrogen electric vehicle is configured to generate electricity by a chemical reaction between hydrogen and oxygen and to travel by driving a motor. More specifically, the hydrogen electric vehicle includes a hydrogen tank (H₂ Tank) configured to store hydrogen (H₂), a fuel cell stack configured to produce (i.e., generate) electricity by an oxidation-reduction reaction between hydrogen and oxygen (O₂), various types of devices configured to discharge produced water, a battery configured to store the electricity produced by the fuel cell stack, a controller configured to convert and control the produced electricity, and a motor configured to generate driving power.

A TYPE 4 pressure vessel may be used as the hydrogen tank of the hydrogen electric vehicle. The TYPE 4 pressure vessel includes a liner (e.g., a nonmetallic material), and a carbon fiber layer made by winding a carbon fiber composite material around an outer surface of the liner.

In addition, a boss is provided at an end of the pressure vessel (hydrogen tank) and connected to a connection target (e.g., a pipe, a valve, or the like). The boss has an inflow/outflow path through which hydrogen flows inward or outward (i.e., through which hydrogen is introduced or discharged).

A sealing performance of connecting parts (e.g., a regulator, a hydrogen shut-off valve, a hydrogen supply valve, and fitting parts for pipes) in the hydrogen supply line for supplying the hydrogen in the hydrogen electric vehicle is one of the most important performances related to safety of a hydrogen supply system, and more particularly, to safety of the entire fuel cell system.

In particular, because secondary damage such as a fire may occur when hydrogen leaks from the boss of the pressure vessel to which the pipe (or the valve) is connected, the sealability needs to be ensured at the connection part (boss) of the pressure vessel.

In general, an O-ring made of a rubber material (e.g., Ethylene Propylene Diene Monomer, i.e., EPDM) is mounted in a gap between the boss and the liner of the pressure vessel, and the sealability is maintained by the O-ring.

However, in a fuel cell system in which the hydrogen is supplied at a high pressure (e.g., 350 bar or higher), there is a problem in that the sealing performance and the leakproof sealability cannot be sufficiently ensured only by the O-ring.

In particular, when the sealing performance of the O-ring is degraded by repeated low-temperature contraction and degradation of the O-ring, there is a problem in that hydrogen leaks through the gap between the boss and the liner.

Therefore, recently, various studies have been conducted to minimize a leak of hydrogen through the gap between the boss and the liner and improve stability and reliability, but the study results are still insufficient. Accordingly, there is a need to develop a technology to minimize a leak of hydrogen through the gap between the boss and the liner and improve stability and reliability.

### SUMMARY

The present disclosure has been made in an effort to provide a pressure vessel capable of improving sealing performance, safety, and reliability.

In particular, the present disclosure has been made in an effort to minimize a leak of hydrogen through a gap between a boss and a liner.

Among other things, the present disclosure has been made in an effort to effectively seal the gap between the boss and the liner by a triple sealing structure.

The present disclosure has also been made in an effort to simplify a structure and a manufacturing process and reduce costs.

The present disclosure has also been made in an effort to reduce a risk of a leak of hydrogen, improve durability, and extend a lifespan.

The objects to be achieved by embodiments of the present disclosure are not limited to the above-mentioned objects, but also include objects or effects that may be understood from the solutions or embodiments described below.

In order to achieve the above-mentioned objects, an embodiment of the present disclosure provides a pressure vessel. The pressure vessel includes a liner configured to store a target fluid and a boss provided at an end of the liner. The pressure vessel also includes a liner neck part including a first neck portion bent from and connected to the end of the liner and configured to define a first sealing surface provided to contact the boss, a second neck portion bent from and connected to an end of the first neck portion and configured to define a second sealing surface provided to contact the boss, and a third neck portion bent from and connected to an end of the second neck portion and configured to define a third sealing surface provided to contact the boss. The pressure vessel also includes a pressing part configured to press the first neck portion, the second neck portion, and the third neck portion against the boss.

This is to ensure sealing performance of the pressure vessel and improve safety and reliability.

In other words, in the related art, an O-ring (or a gasket) made of rubber is mounted in a connecting part in a hydrogen supply line in order to maintain leakproof sealability. However, in a fuel cell system in which hydrogen is supplied at a high pressure (e.g., 350 bar or higher), there is a problem in that the sealing performance and the leakproof sealability cannot be sufficiently ensured only by the O-ring.

In particular, when the sealing performance of the O-ring is degraded by repeated low-temperature contraction and degradation of the O-ring, there is a problem in that hydrogen leaks through the gap between the boss and the liner.

In contrast, in an embodiment of the present disclosure, the triple sealing section may be provided between the boss and the liner by providing the liner neck part. The liner neck part may include the first neck portion, the second neck portion, and the third neck portion. The triple sealing section may also allow the pressing part to press the first neck portion, the second neck portion, and the third neck portion against the boss. Therefore, it is possible to obtain an advantageous effect of minimizing a leak of hydrogen through the gap between the boss and the liner.

In an embodiment of the present disclosure, the gap between the boss and the liner may be sealed by the triple sealing structure implemented by the liner neck part and the pressing part, such that the gap between the boss and the liner may be effectively sealed in a sealless manner excluding an O-ring. Therefore, it is possible to obtain an advantageous effect of reducing a risk of a leak of hydrogen and improving the safety and reliability.

The liner neck part may have various structures capable of including the first neck portion, the second neck portion, and the third neck portion and defining the triple sealing section.

According to an embodiment of the present disclosure, the first neck portion may be provided in a longitudinal direction of the liner, the second neck portion may be provided in a radial direction of the liner, and the third neck portion may be provided in the longitudinal direction of the liner so as to face the second neck portion.

The first sealing surface, the second sealing surface, and the third sealing surface may be continuously connected along a periphery of the liner neck part.

According to an embodiment of the present disclosure, the liner neck part may include: a first contact surface provided on an inner surface of the first neck portion; a second contact surface provided on an inner surface of the second neck portion; and a third contact surface provided on an inner surface of the third neck portion. The pressing part may be configured to press the first contact surface, the second contact surface, and the third contact surface.

In particular, the first contact surface, the second contact surface, and the third contact surface may collectively define a wedge groove having a cross-sectional area that gradually decreases from one end, which is adjacent to the pressing part, toward the other end.

The pressing part may have various structures capable of pressing the first neck portion, the second neck portion, and the third neck portion against the boss.

According to an embodiment of the present disclosure, the pressing part may include a fastening member fastened to the boss and configured to be movable in a direction toward or away from the second contact surface and may include a pressing block provided at one end of the fastening member, which faces the second contact surface. The pressing block may be configured to press the first contact surface, the second contact surface, and the third contact surface based on a fastening force applied by the fastening member.

The structure for fastening the fastening member and the boss may be variously changed in accordance with required conditions and design specifications.

According to an embodiment of the present disclosure, the pressure vessel may include a first screw fastening portion provided on an outer peripheral surface of the fastening member and may include a second screw fastening portion provided on the boss and configured to engage with the first screw fastening portion. The pressing block may rectilinearly move in the direction toward or away from the second contact surface based on a rotation of the fastening member relative to the boss.

As described above, the pressing block may be rectilinearly moved in the direction toward or away from the second contact surface, without rotating, by the rotation of the fastening member relative to the boss. Thus, the smooth movement of the pressing block relative to the liner neck part may be ensured and the fastening member may be fastened to the boss in a state in which frictional resistance caused by the pressing block is minimized.

The pressing block may have various structures capable of pressing the first contact surface, the second contact surface, and the third contact surface based on the fastening force applied by the fastening member.

According to an embodiment of the present disclosure, the pressing block may have a cross-sectional area that gradually increases from one end, which is adjacent to the second contact surface, toward the other end.

According to an embodiment of the present disclosure, the pressure vessel may include a first concave-convex pattern provided on at least any one of the first sealing surface and the third sealing surface and may include a second concave-convex pattern provided on the boss and corresponding to the first concave-convex pattern.

In other words, this is based on the fact that because of the structural feature in which the pressing block presses the liner neck part while moving in the direction toward the second neck portion, the pressing force (surface pressure), which is relatively higher than the pressing forces applied to the first neck portion and the third neck portion, is applied to the second neck portion. The first concave-convex pattern may be provided on at least any one of the first sealing surface and the third sealing surface. The second concave-convex pattern, which corresponds to the first concave-convex pattern, may be provided on the inner surface of the boss facing the first concave-convex pattern (e.g., the inner surface of the boss flange portion). Thus, the higher pressing forces may be applied to the first neck portion and the third neck portion.

According to an embodiment of the present disclosure, the pressure vessel may include: a pressure application groove provided in the fastening member such that the pressure application groove is exposed to the target fluid and configured to allow pressure applied by the target fluid to be applied to the pressure application groove.

As described above, the pressure application groove may be provided in the fastening member, such that an area, in which the pressure is applied to the fastening member by the target fluid, may be further expanded. Therefore, it is possible to obtain an advantageous effect of minimizing a degree to which the fastening member is pushed and further increasing the pressing forces applied to the first neck portion, the second neck portion, and the third neck portion by the fastening member.

According to an embodiment of the present disclosure, the pressure vessel may include a through-hole configured to communicate with (i.e., is connected to) the pressure application groove and provided in the fastening member such that the pressing block is exposed. The pressure applied by the target fluid may be applied to the pressing block through the through-hole.

As described above, the through-hole may be provided in the fastening member, such that the pressure applied by the target fluid may be applied directly to the pressing block. Therefore, it is possible to obtain an advantageous effect of maximizing the pressing forces applied to the first neck portion, the second neck portion, and the third neck portion by the fastening member.

According to an embodiment of the present disclosure, the boss may include a guide surface configured to face the first neck portion and guide an inner peripheral surface of the pressing block between the third neck portion and the fastening member.

As described above, the guide surface, which has higher rigidity than the first neck portion (the liner neck part), may be provided below the third neck portion, such that deformation of the third neck portion may be minimized, and the pressing force (surface pressure) applied to the third neck portion may be higher than the pressing force (surface pressure) applied to the first neck portion. Therefore, it is possible to obtain an advantageous effect of more stably ensuring the performance in sealing the third neck portion (the third sealing surface) that is a point from which a leak of the target fluid is initiated.

According to an embodiment of the present disclosure, the pressing block may include a first block portion configured to press the second contact surface and may include a second block portion provided at an end of the first block portion The second block portion may have a larger cross-sectional area than the first block portion and be configured to press the first contact surface and the third contact surface.

As described above, the second block portion, which corresponds to a rear end of the pressing block, may have a relatively larger cross-sectional area than the first block portion corresponding to a tip of the pressing block, such that it is possible to ensure that the pressing block smoothly enters the inside of the liner neck part. It is also possible to further increase the pressing forces applied to the first neck portion and the third neck portion. Therefore, it is possible to obtain an advantageous effect of minimizing a deviation between the pressing forces applied to the first neck portion, the second neck portion, and the third neck portion and further improving the stability and reliability of the triple sealing section implemented by the first neck portion, the second neck portion, and the third neck portion.

According to an embodiment of the present disclosure, the pressure vessel may include a support protrusion provided at an end of the fastening member such that the support protrusion faces an inner surface of the liner.

According to an embodiment of the present disclosure, the pressure vessel may include: a surface treatment layer having micro-voids provided on a surface thereof. The surface treatment layer may be provided on an inner surface of the boss that corresponds to at least any one of the first sealing surface, the second sealing surface, and the third sealing surface.

According to an embodiment of the present disclosure, the pressure vessel may include a micro-void filling layer integrally connected to the liner neck part and configured to fill the micro-voids.

According to an embodiment of the present disclosure, the pressure vessel may include a bonding layer provided on an inner surface of the boss that corresponds to at least any one of the first sealing surface, the second sealing surface, and the third sealing surface.

### BRIEF DESCRIPTION OF THE DRAWINGS

FIG. 1 is a view for explaining a pressure vessel according to an embodiment of the present disclosure.

FIG. 2 is a view for explaining a liner neck part of the pressure vessel according to an embodiment of the present disclosure.

FIG. 3 is a view for explaining pressure applied to the liner neck part of the pressure vessel according to an embodiment of the present disclosure.

FIG. 4 is a view for explaining a first concave-convex pattern and a second concave-convex pattern of the pressure vessel according to an embodiment of the present disclosure.

FIG. 5 is a view for explaining pressure applied to the liner neck part based on the first concave-convex pattern and the second concave-convex pattern of the pressure vessel according to an embodiment of the present disclosure.

FIG. 6 is a view for explaining a first block portion and a second block portion of the pressure vessel according to an embodiment of the present disclosure.

FIG. 7 is a view for explaining pressure applied to the liner neck part based on the first block portion and the second block portion of the pressure vessel according to an embodiment of the present disclosure.

FIG. 8 is a view for explaining a surface treatment layer of the pressure vessel according to an embodiment of the present disclosure.

FIG. 9 is a view for explaining a bonding layer of the pressure vessel according to an embodiment of the present disclosure.

### DETAILED DESCRIPTION

Hereinafter, embodiments of the present disclosure are described in detail with reference to the accompanying drawings.

However, the technical spirit of the present disclosure is not limited to some embodiments described herein but may be implemented in various different forms. One or more of the constituent elements in embodiments may be selectively combined and substituted for use within the scope of the technical spirit of the present disclosure.

In addition, unless otherwise specifically and explicitly defined and stated, the terms (including technical and scientific terms) used in embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in embodiments of the present disclosure are for explaining embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

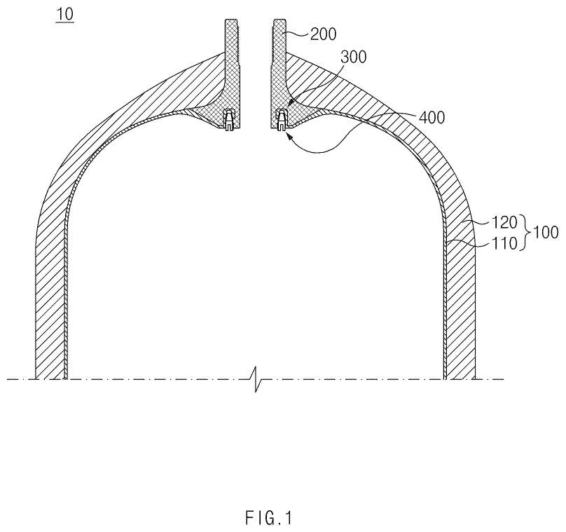

With reference to FIGS. 1-9, a pressure vessel 10 according to an embodiment of the present disclosure includes a liner 110 configured to store a target fluid, a boss 200 provided at an end of the liner 110, and a liner neck part 300. The liner neck part 300 includes a first neck portion 310 bent from and connected to the end of the liner 110 and configured to define a first sealing surface 312 provided to be in contact with the boss 200. The liner neck part 300 also includes a second neck portion 320 bent from and connected to an end of the first neck portion 310 and configured to define a second sealing surface 322 provided to be in contact with the boss 200. The liner neck part 300 also includes a third neck portion 330 bent from and connected to an end of the second neck portion 320 and configured to define a third sealing surface 332 provided to be in contact with the boss 200. The pressure vessel 10 further includes a pressing part 400 configured to press the first neck portion 310, the second neck portion 320, and the third neck portion 330 against the boss 200.

For reference, the pressure vessel 10 according to an embodiment of the present disclosure may be used to store a high-pressure target fluid (liquid or gas). The present disclosure is not restricted or limited by the type and property of the target fluid to be stored in the pressure vessel 10.

Hereinafter, an example is described in which the pressure vessel 10 according to an embodiment of the present disclosure is used as a hydrogen tank for a fuel cell system applied to mobility vehicles such as various fuel cell electric vehicles (e.g., passenger vehicles or commercial vehicles), ships, and aircraft to which a fuel cell stack may be applied.

The liner 110 may have a hollow structure having a storage space therein, and high-pressure compressed hydrogen (target fluid) may be stored in the storage space.

The liner 110 may have various structures in accordance with required conditions and design specifications. The present disclosure is not restricted or limited by the structure and shape of the liner 110.

According to an embodiment of the present disclosure, the liner 110 may include a cylinder portion (not illustrated) having a hollow cylindrical shape, and side portions (not illustrated) each having an approximately dome shape and integrated with two opposite ends of the cylinder portion.

The liner 110 may be variously changed in material in accordance with required conditions and design specifications. The present disclosure is not restricted or limited by the material of the liner 110. In particular, the liner 110 may be made of a nonmetallic material, such as high-density plastic (e.g., polyamide resin), excellent in restoring force and fatigue resistance.

For example, the liner 110 may be integrated with the boss 200 by injection molding.

According to an embodiment of the present disclosure, the pressure vessel 10 may include a reinforcement layer 120 provided to surround a periphery of the liner 110. The reinforcement layer 120, together with the liner 110, may constitute a vessel main body 100.

With reference to FIG. 1, the reinforcement layer 120 may be provided to ensure resistance (structural rigidity) against stress applied to the liner 110 and surround the entire outer peripheral surface of the liner 110.

The reinforcement layer 120 may have various structures and be made of various materials in accordance with required conditions and design specifications. The present disclosure is not restricted or limited by the structure and material of the reinforcement layer 120.

According to an embodiment of the present disclosure, the reinforcement layer 120 may be made of at least any one of reinforcing fiber, thermosetting resin, and thermoplastic resin.

Hereinafter, an example is described in which the reinforcement layer 120 is made of a carbon fiber composite material including a carbon fiber which is a kind of reinforcing fiber.

For example, the reinforcement layer 120 may be made by winding a carbon fiber composite material around the outer surface (outer peripheral surface) of the liner 110 by using a typical winding device.

The structure of the wound carbon fiber composite material and the method of winding the carbon fiber composite material may be variously changed in accordance with required conditions and design specifications. The present disclosure is not limited or restricted by the method of winding the carbon fiber composite material. For example, the reinforcement layer 120 may be made by winding multiple layers of the carbon fiber composite material around the outer surface of the liner 110 in various patterns (e.g., clockwise winding, counterclockwise winding, oblique winding, and the like).

According to another embodiment of the present disclosure, the reinforcement layer 120 may be made by applying a process method such as filament winding, braiding, multi-filament winding, or the like using an intermediate material (prepreg, towpreg, and the like) made by impregnating reinforcing fiber (e.g., carbon fiber, fiberglass, aramid fiber, limestone fiber, and the like) with thermosetting or thermoplastic resin in advance and then partially curing the resin.

With reference to FIG. 1, the boss 200 is provided at an end of the liner 110 (e.g., one end of the liner 110 or two opposite ends of the liner 110) to define an inflow/outflow path (not illustrated), through which the target fluid (e.g., hydrogen) flows inward or outward (is introduced or discharged), and define an accommodation space (not illustrated) in which a connection target (not illustrated) is accommodated (connected).

For reference, in an embodiment of the present disclosure, the connection target may be defined as a component capable of being connected to the boss 200 to allow the target fluid stored in the pressure vessel 10 to enter or exit (move to or from) the boss 200. The present disclosure is not restricted or limited by the type and structure of the connection target.

For example, the connection target may include a nipple, to which pipes or various types of components (e.g., manifolds) may be connected, and a valve configured to selectively adjust a movement of the target fluid.

The boss 200 may have various structures capable of being integrally connected to the end of the liner 110 (e.g., by double injection molding). The present disclosure is not restricted or limited by the structure and shape of the boss 200.

For example, the boss 200 may include a boss body portion (not illustrated) configured to define the inflow/outflow path for the target fluid, and a boss flange portion provided at an end of the boss body portion and having a larger cross-sectional area than the boss body portion. Hereinafter, an example is described in which the boss body portion and the boss flange portion are provided to collectively define an approximately “T” cross-sectional shape.

The boss 200 may be made of various materials in accordance with required conditions and design specifications. The present disclosure is not restricted or limited by the material of the boss 200.

In particular, the boss 200 may have relatively higher strength than the liner neck part 300 (or the liner). For example, the boss 200 may be made of an aluminum alloy (e.g., AL6061-T6).

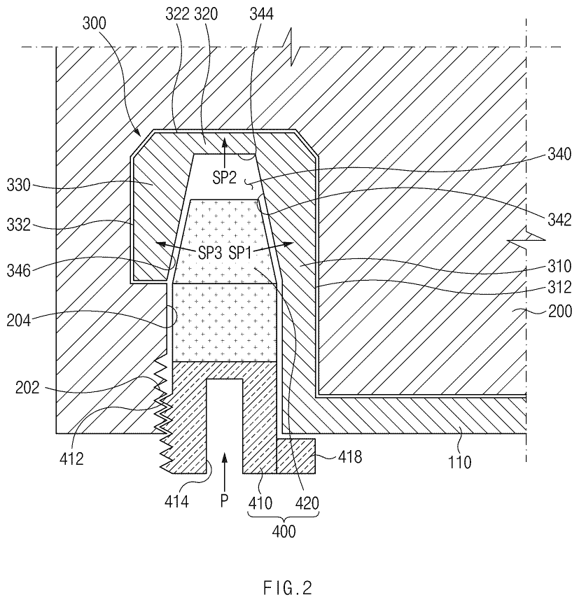

With reference to FIGS. 1 and 2, the liner neck part 300 is integrated with the end of the liner 110 to define a sealing section between the boss 200 and the liner 110.

More specifically, the liner neck part 300 includes the first neck portion 310 bent from and continuously connected to the end of the liner 110 and configured to define the first sealing surface 312 provided to be in contact with the boss 200. The liner neck part 300 also includes the second neck portion 320 bent from and continuously connected to the end of the first neck portion 310 and configured to define the second sealing surface 322 provided to be in contact with the boss 200. The liner neck part 300 also includes the third neck portion 330 bent from and continuously connected to the end of the second neck portion 320 and configured to define the third sealing surface 332 provided to be in contact with the boss 200.

The liner neck part 300 may have various structures capable of including the first neck portion 310, the second neck portion 320, and the third neck portion 330 and defining a triple sealing section. The present disclosure is not restricted or limited by the structure of the liner neck part 300.

According to an embodiment of the present disclosure, the first neck portion 310 may be provided in a longitudinal direction of the liner 110 (an upward/downward direction based on FIG. 2), the second neck portion 320 may be provided in a radial direction of the liner 110 (a leftward/rightward direction based on FIG. 2), and the third neck portion 330 may be provided in the longitudinal direction of the liner 110 (the upward/downward direction based on FIG. 2) so as to face the first neck portion 310.

For example, the first neck portion 310, the second neck portion 320, and the third neck portion 330 may be provided to collectively define an approximately “U” shape. The first sealing surface 312, the second sealing surface 322, and the third sealing surface 332 may each have a flat surface shape. Alternatively, the first sealing surface, the second sealing surface, and the third sealing surface may each have a curved shape or other shapes.

In particular, the first sealing surface 312, the second sealing surface 322, and the third sealing surface 332 may be continuously connected to define an approximately “U” shape along a periphery of the liner neck part 300 (peripheries of the first neck portion 310, the second neck portion 320, and the third neck portion 330). According to another embodiment of the present disclosure, the first sealing surface, the second sealing surface, and the third sealing surface may be spaced apart from one another at predetermined intervals.

According to an embodiment of the present disclosure, the liner neck part 300 may include a first contact surface 342 provided on an inner surface (a surface facing the pressing part) of the first neck portion 310, a second contact surface 344 provided on an inner surface (a surface facing the pressing part) of the second neck portion 320, and a third contact surface 346 provided on an inner surface (a surface facing the pressing part) of the third neck portion 330. The pressing part 400 may be configured to simultaneously press the first contact surface 342, the second contact surface 344, and the third contact surface 346.

In particular, the first contact surface 342, the second contact surface 344, and the third contact surface 346 may be configured to collectively define a wedge groove 340 having an approximately trapezoidal cross-sectional shape having a cross-sectional area that gradually decreases from one end (a lower end based on FIG. 2), which is adjacent to the pressing part 400, toward the other end (an upper end based on FIG. 2).

For example, the first contact surface 342 and the third contact surface 346 may be inclined at a predetermined angle with respect to the longitudinal direction of the liner 110 (the upward/downward direction based on FIG. 2), and the second contact surface 344 may be provided in parallel with the radial direction of the liner 110 (the leftward/rightward direction based on FIG. 2).

In an embodiment of the present disclosure illustrated and described above, the example has been described in which the first contact surface 342, the second contact surface 344, and the third contact surface 346 collectively define the wedge groove 340 having an approximately trapezoidal cross-sectional shape. However, according to another embodiment of the present disclosure, the first contact surface, the second contact surface, and the third contact surface may define a quadrangular groove or grooves with other shapes.

The pressing part 400 is configured to press the first neck portion 310, the second neck portion 320, and the third neck portion 330 against the boss 200.

In this case, the configuration in which the pressing part 400 presses the first neck portion 310, the second neck portion 320, and the third neck portion 330 against the boss 200 may be defined as a configuration in which pressing forces SP1, SP2, and SP3 are applied to the first neck portion 310, the second neck portion 320, and the third neck portion 330 so that the first sealing surface 312, the second sealing surface 322, and the third sealing surface 332 are in close contact with the boss 200.

The pressing part 400 may have various structures capable of pressing the first neck portion 310, the second neck portion 320, and the third neck portion 330 against the boss 200. The present disclosure is not restricted or limited by the type and structure of the pressing part 400.

According to an embodiment of the present disclosure, the pressing part 400 may include a fastening member 410 fastened to the boss 200 and configured to be movable in a direction toward or away from the second contact surface 344 (the upward/downward direction based on FIG. 2). The pressing part 400 may also include a pressing block 420 provided at one end of the fastening member 410, which faces the second contact surface 344, and configured to press the first contact surface 342, the second contact surface 344, and the third contact surface 346 based on a fastening force implemented by the fastening member 410.

For example, the fastening member 410 and the pressing block 420 may have an approximately ring shape that surrounds a periphery of the boss 200.

The structure for fastening the fastening member 410 and the boss 200 may be variously changed in accordance with required conditions and design specifications. The present disclosure is not restricted or limited by the structure for fastening the fastening member 410 and the boss 200.

According to an embodiment of the present disclosure, the pressure vessel 10 may include a first screw fastening portion 412 provided on an outer peripheral surface of the fastening member 410 and may include a second screw fastening portion 202 provided on the boss 200 and configured to engage with the first screw fastening portion 412. The pressing block 420 may rectilinearly move in a direction toward or away from the second contact surface 344 (the upward/downward direction based on FIG. 2) based on a rotation of the fastening member 410 relative to the boss 200.

For example, the first screw fastening portion 412 may be provided in an internal thread shape, and the second screw fastening portion 202 may be provided in an external thread shape. When the fastening member 410 is rotated relative to the boss 200, the fastening member 410 may rectilinearly move in the direction toward or away from the boss 200 at the same time when the second screw fastening portion 202 is fastened to the first screw fastening portion 412.

As described above, in an embodiment of the present disclosure, the pressing block 420 is rectilinearly moved in the direction toward or away from the second contact surface 344, without rotating, by the rotation of the fastening member 410 relative to the boss 200. Thus, the smooth movement of the pressing block 420 relative to the liner neck part 300 may be ensured, and the fastening member 410 may be fastened to the boss 200 in a state in which frictional resistance caused by the pressing block 420 is minimized.

The pressing block 420 may have various structures capable of pressing the first contact surface 342, the second contact surface 344, and the third contact surface 346 based on the fastening force implemented by the fastening member 410. The present disclosure is not restricted or limited by the structure and shape of the pressing block 420.

According to an embodiment of the present disclosure, the pressing block 420 may have an approximately trapezoidal cross-sectional shape (wedge shape) having a cross-sectional area that gradually increases from one end (an upper end based on FIG. 2), which is adjacent to the second contact surface 344, toward the other end. Alternatively, the pressing block may have a spherical shape or other shapes.

As described above, in an embodiment of the present disclosure, the triple sealing section may be provided between the boss 200 and the liner 110 by providing the liner neck part 300, which includes the first neck portion 310, the second neck portion 320, and the third neck portion 330, and allowing the pressing part 400 to press the first neck portion 310, the second neck portion 320, and the third neck portion 330 against the boss 200 so that the first sealing surface 312, the second sealing surface 322, and the third sealing surface 332 are in close contact with the boss 200. Therefore, it is possible to obtain an advantageous effect of minimizing a leak of the target fluid (e.g., hydrogen) through the gap between the boss 200 and the liner 110.

In particular, in an embodiment of the present disclosure, the gap between the boss 200 and the liner 110 is sealed by the triple sealing structure implemented by the liner neck part 300 and the pressing part 400. Thus, the gap between the boss 200 and the liner 110 may be effectively sealed in a sealless manner excluding an O-ring. Therefore, it is possible to obtain an advantageous effect of reducing a risk of a leak of the target fluid (e.g., hydrogen) and improving the safety and reliability.

According to an embodiment of the present disclosure, the pressure vessel 10 may include a support protrusion 418 provided at an end of the fastening member 410 so as to face the inner surface of the liner 110.

For example, the support protrusion 418 may be provided to protrude from the end of the fastening member 410 (protrude in the radial direction of the liner) so as to face a lower end (based on FIG. 2) of the first neck portion 310.

The support protrusion 418 may have various structures in accordance with required conditions and design specifications. The present disclosure is not restricted or limited by the structure and shape of the support protrusion 418. For example, the support protrusion 418 may be provided in a continuous ring shape along a periphery of the fastening member 410 so as to have a quadrangular cross-sectional shape.

As described above, in an embodiment of the present disclosure, the support protrusion 418 is provided at the end of the fastening member 410. The support protrusion 418 supports the lower end of the first neck portion 310 when the fastening member 410 allows the pressing block 420 to press the liner neck part 300. Therefore, it is possible to obtain an advantageous effect of minimizing deformation of the liner neck part 300 (e.g., deformation in which the lower end of the first neck portion is moved downward by the pressing force of the pressing block) and further increasing surface pressure applied to the liner neck part 300.

According to an embodiment of the present disclosure, the pressure vessel 10 may include a first concave-convex pattern 350 provided on at least any one of the first sealing surface 312 and the third sealing surface 332 and may include a second concave-convex pattern 206 provided on the boss 200 and corresponding to the first concave-convex pattern 350.

The first concave-convex pattern 350 and the second concave-convex pattern 206 are configured to apply a higher pressing force to the first neck portion 310 (the first sealing surface) and the third neck portion 330 (the third sealing surface).

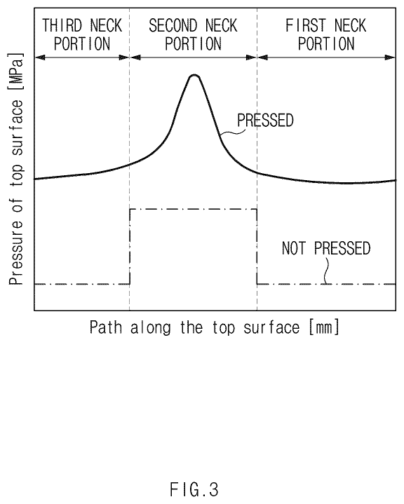

This is based on the fact that as illustrated in FIG. 3, because of the structural feature in which the pressing block 420 presses the liner neck part 300 while moving in the direction toward the second neck portion 320, the pressing force (surface pressure) SP2, which is relatively higher than the pressing forces SP1 and SP3 applied to the first neck portion 310 and the third neck portion 330, is applied to the second neck portion 320. In an embodiment of the present disclosure, the first concave-convex pattern 350 is provided on at least any one of the first sealing surface 312 and the third sealing surface 332. The second concave-convex pattern 206, which corresponds to the first concave-convex pattern 350, is provided on the inner surface of the boss 200 facing the first concave-convex pattern 350 (the inner surface of the accommodation groove of the boss in which the liner neck part is accommodated). Thus, the higher pressing forces SP1 and SP3 may be applied to the first neck portion 310 (the first sealing surface) and the third neck portion 330 (the third sealing surface).

Hereinafter, an example is described in which the first concave-convex patterns 350 are respectively provided on the first sealing surface 312 and the third sealing surface 332.

The first concave-convex pattern 350 and the second concave-convex pattern 206 may have various structures in accordance with required conditions and design specifications. The present disclosure is not restricted or limited by the structures and shapes of the first concave-convex pattern 350 and the second concave-convex pattern 206.

For example, the first concave-convex pattern 350 and the second concave-convex pattern 206 may each have an approximately screw thread (serrated) shape. The first concave-convex pattern 350 and the second concave-convex pattern 206 may be in close contact with each other while engaging with each other.

As described above, in an embodiment of the present disclosure, the first concave-convex patterns 350 are provided on the first sealing surface 312 and the third sealing surface 332. The second concave-convex pattern 206, which corresponds to the first concave-convex patterns 350, is provided on the inner surface of the boss 200 facing the first concave-convex pattern 350, such that it is possible to further increase the pressing forces applied to the first neck portion 310 (the first sealing surface) and the third neck portion 330 (the third sealing surface). Therefore, it is possible to obtain an advantageous effect of minimizing a deviation between the pressing forces applied to the first neck portion 310, the second neck portion 320, and the third neck portion 330 and further improving the stability and reliability of the triple sealing section implemented by the first neck portion 310, the second neck portion 320, and the third neck portion 330.

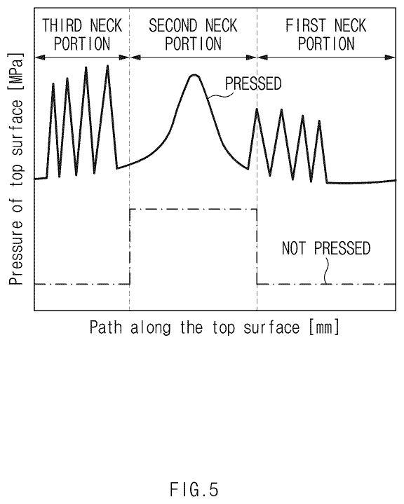

In other words, with reference to FIG. 5, it can be ascertained that the pressing forces (surface pressure) applied to the first neck portion 310 and the third neck portion 330 are increased while corresponding to the first concave-convex pattern 350 and the second concave-convex pattern 206 by providing the first concave-convex patterns 350 on the first sealing surface 312 (the first neck portion) and the third sealing surface 332 (the third neck portion) and providing the second concave-convex pattern 206 on the boss 200.

According to an embodiment of the present disclosure, the pressure vessel 10 may include a pressure application groove 414 provided in the fastening member 410 so as to be exposed to the target fluid and configured to allow pressure P applied by the target fluid to be applied to the pressure application groove 414.

The pressure application groove 414 may be provided at various positions on the fastening member 410 at which the pressure application groove 414 may be exposed to the target fluid. The present disclosure is not restricted or limited by the position and structure in which the pressure application groove 414 is provided.

For example, the pressure application groove 414 may have an approximately circular cross-sectional shape and be provided at one end of the fastening member 410 (a lower end of the fastening member 410 based on FIG. 2) that faces the internal space of the liner 110. Alternatively, the pressure application groove 414 may be provided in a side surface of the fastening member 410 or at other positions.

As described above, in an embodiment of the present disclosure, the pressure application groove 414 is provided in the fastening member 410, such that an area, in which the pressure P is applied to the fastening member 410 by the target fluid, may be further expanded. Therefore, it is possible to obtain an advantageous effect of minimizing a degree to which the fastening member 410 is pushed (moved in the downward direction based on FIG. 2) and further increasing the pressing forces applied to the first neck portion 310, the second neck portion 320, and the third neck portion 330 by the fastening member 410.

According to an embodiment of the present disclosure, the pressure vessel 10 may include a through-hole 416 provided in the fastening member 410 and configured to communicate with the pressure application groove 414 so that the pressing block 420 is exposed. The pressure P applied by the target fluid may be applied to the pressing block 420 through the through-hole 416.

For example, the through-hole 416 may have a circular hole shape and be provided at the other end of the fastening member 410 (an upper end of the fastening member 410 based on FIG. 2).

As described above, in an embodiment of the present disclosure, the through-hole 416 is provided in the fastening member 410, such that the pressure P applied by the target fluid may be applied directly to the pressing block 420. Therefore, it is possible to obtain an advantageous effect of maximizing the pressing forces applied to the first neck portion 310, the second neck portion 320, and the third neck portion 330 by the fastening member 410.

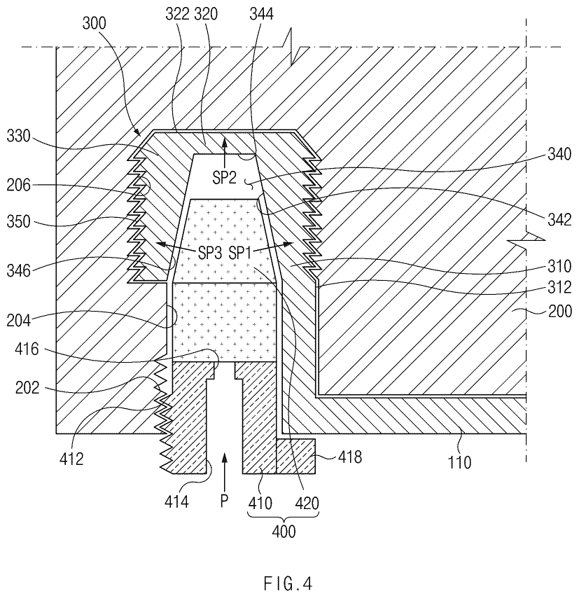

With reference to FIG. 4, according to an embodiment of the present disclosure, the boss 200 may include a guide surface 204 provided to face the first neck portion 310 and configured to guide an inner peripheral surface of the pressing block 420 between the third neck portion 330 and the fastening member 410.

As described above, in an embodiment of the present disclosure, the guide surface 204, which has higher rigidity than the first neck portion 310 (the liner neck part), is provided below the third neck portion 330 having a shorter length (length in the upward/downward direction based on FIG. 2) than the first neck portion 310. Thus, deformation of the third neck portion 330 may be minimized and the pressing force (surface pressure) applied to the third neck portion 330 may be higher than the pressing force (surface pressure) applied to the first neck portion 310 (see FIG. 5). Therefore, it is possible to obtain an advantageous effect of more stably ensuring the performance in sealing the third neck portion 330 (the third sealing surface) that is a point from which a leak of the target fluid is initiated.

In an embodiment of the present disclosure illustrated and described above, an example has been described in which the pressing block 420 is provided to define a single stepped portion (have a single block portion). However, according to another embodiment of the present disclosure, a pressing block 420′ may have a multi-stepped structure including a plurality of block portions.

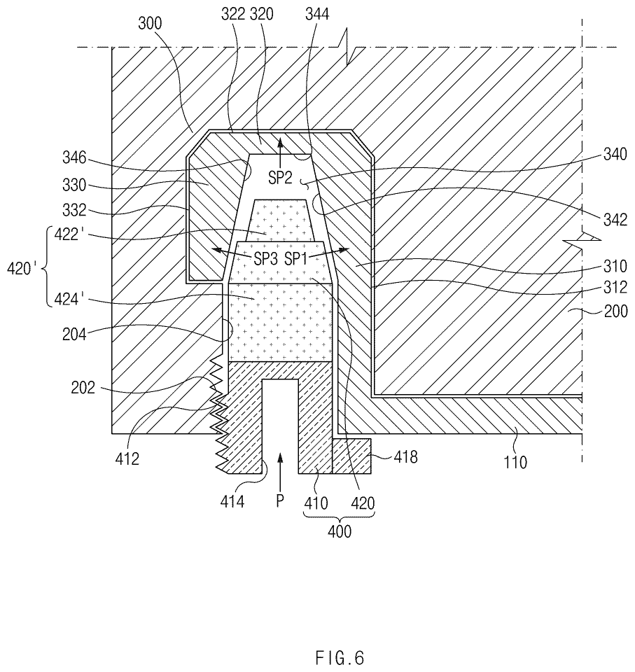

For example, with reference to FIG. 6, the pressing block 420′ may include a first block portion 422′ configured to press the second contact surface 344 and may include a second block portion 424′ provided at an end (a lower end based on FIG. 6) of the first block portion 422′ so as to have a larger cross-sectional area than the first block portion 422′ and configured to press the first contact surface 342 and the third contact surface 346.

As described above, the second block portion 424′, which corresponds to a rear end of the pressing block 420′, has a relatively larger cross-sectional area (e.g., a larger width) than the first block portion 422′ corresponding to a tip of the pressing block 420′ (a tip configured to enter the inside of the liner neck part 300 first). Thus, it is possible to ensure that the pressing block 420′ smoothly enters the inside (wedge groove) of the liner neck part 300 and it is possible to further increase the pressing forces SP1 and SP3 applied to the first neck portion 310 (the first sealing surface) and the third neck portion 330 (the third sealing surface). Therefore, it is possible to obtain an advantageous effect of minimizing a deviation between the pressing forces applied to the first neck portion 310, the second neck portion 320, and the third neck portion 330 and further improving the stability and reliability of the triple sealing section implemented by the first neck portion 310, the second neck portion 320, and the third neck portion 330.

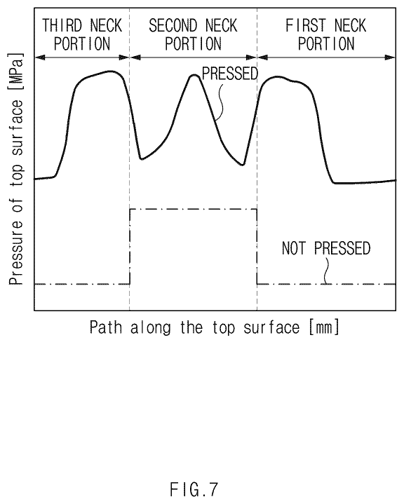

In other words, with reference to FIG. 7, it can be ascertained that the pressing forces (surface pressure) applied to the first neck portion 310 and the third neck portion are increased while corresponding to the pressing force applied to the second neck portion 320 when the pressing block 420′ has the multi-stepped structure including the first block portion 422′ and the second block portion 424′.

In an embodiment of the present disclosure illustrated and described above, the example has been described in which the pressing block 420′ includes the first block portion 422′ and the second block portion 424′. However, according to another embodiment of the present disclosure, the pressing block may include three or more block portions.

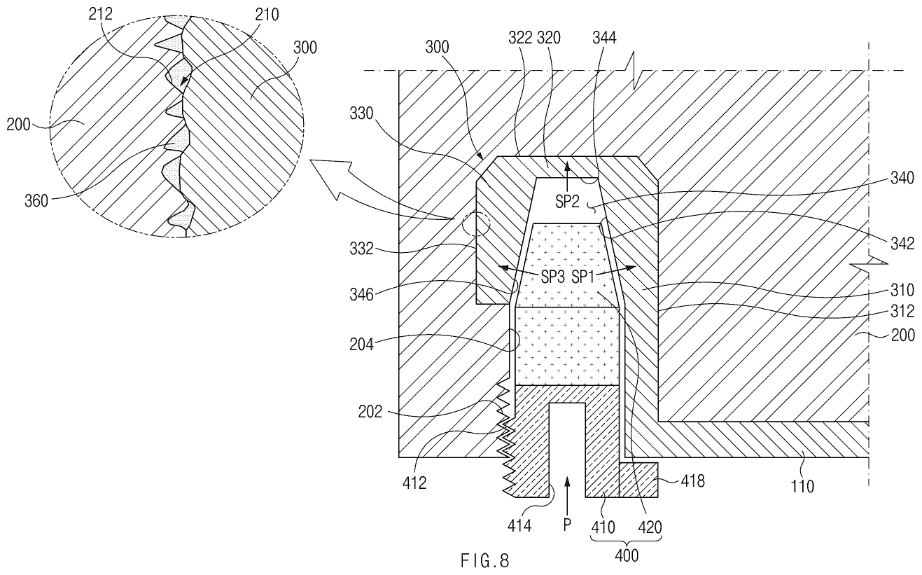

With reference to FIG. 8, according to an embodiment of the present disclosure, the pressure vessel 10 may include a surface treatment layer 210 having micro-voids 212 provided on a surface thereof. The surface treatment layer 210 may be provided on an inner surface of the boss 200 that corresponds to at least any one of the first sealing surface 312, the second sealing surface 322, and the third sealing surface 332.

In this case, the configuration in which the surface of the surface treatment layer 210 has the micro-voids 212 may be understood as a configuration in which a fine concave-convex pattern including the micro-voids 212 is provided on a surface of the surface treatment layer 210 with which the liner neck part 300 is in contact. Hereinafter, an example is described in which the surface treatment layers 210 are respectively provided on the inner surfaces of the boss 200 corresponding to the first sealing surface 312, the second sealing surface 322, and the third sealing surface 332.

The surface treatment layer 210 may be provided by performing surface treatment on the inner surface of the boss 200 (the inner surface of the accommodation groove of the boss in which the liner neck part is accommodated). The present disclosure is not restricted or limited by the surface treatment process method for forming the surface treatment layer 210 having the micro-voids 212.

For example, the surface treatment layer 210 may be provided by etching the inner surface of the boss 200 and then performing the heat treatment (e.g., heat treatment using a coil heater). According to another embodiment of the present disclosure, the surface treatment layer may be provided by a physical surface treatment method (e.g., machine) or other chemical surface treatment method.

According to an embodiment of the present disclosure, the pressure vessel 10 may include a micro-void filling layer 360 integrally connected to the liner neck part 300 and configured to fill the micro-voids 212.

The micro-void filling layer 360 may be provided by filling the micro-voids 212 of the surface treatment layer 210 with resin (a raw material of the liner) during a process of manufacturing the liner 110 (the liner neck part) by injection molding. The micro-void filling layer 360 may be integrally connected to the liner neck part 300.

As described above, in an embodiment of the present disclosure, the micro-void filling layer 360 is provided by filling the micro-voids 212 of the surface treatment layer 210 with a part of resin in a molten state during the process of manufacturing the liner 110 by injection molding. Therefore, it is possible to obtain an advantageous effect of minimizing a leak of the target fluid through the gap between the liner neck part 300 and the boss 200.

Moreover, in an embodiment of the present disclosure, the fine concave-convex pattern including the micro-voids 212 is provided on the surface of the surface treatment layer 210, such that it is possible to further increase the pressing forces applied to the first neck portion 310 (the first sealing surface), the second neck portion 320 (the second sealing surface), and the third neck portion 330 (the third sealing surface). Therefore, it is possible to obtain an advantageous effect of minimizing a deviation between the pressing forces applied to the first neck portion 310, the second neck portion 320, and the third neck portion 330 and further improving the stability and reliability of the triple sealing section implemented by the first neck portion 310, the second neck portion 320, and the third neck portion 330.

Moreover, because the micro-void filling layer 360, which fills the micro-voids 212, is integrally connected to the liner neck part 300, it is possible to obtain an advantageous effect of stably maintaining (fixing) the arrangement state of the liner neck part 300 with respect to the boss 200 and minimizing the withdrawal and deformation of the liner neck part 300.

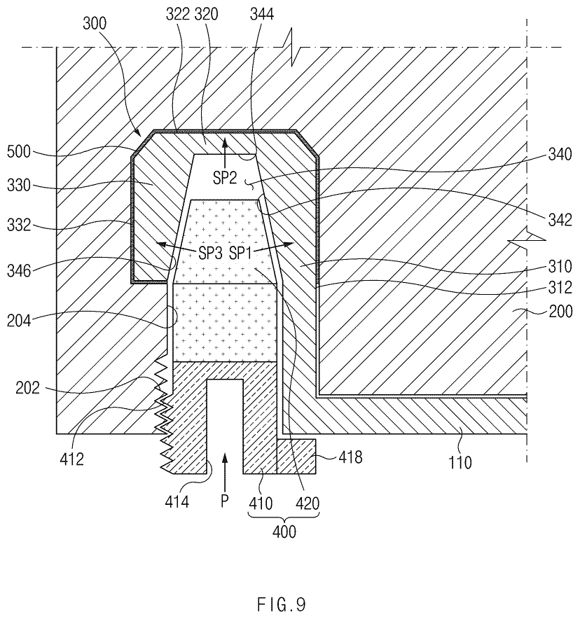

With reference to FIG. 9, according to an embodiment of the present disclosure, the pressure vessel 10 may include a bonding layer 500 provided on the inner surface of the boss 200 (the inner surface of the accommodation groove of the boss in which the liner neck part is accommodated) corresponding to at least any one of the first sealing surface 312, the second sealing surface 322, and the third sealing surface 332.

Hereinafter, an example is described in which the bonding layers 500 are respectively provided on the inner surfaces of the boss 200 corresponding to the first sealing surface 312, the second sealing surface 322, and the third sealing surface 332.

The bonding layer 500 may serve to seal the gap between the liner neck part 300 and the boss 200 and fix the liner neck part 300 to the boss 200.

The bonding layer 500 may be provided by applying a typical bonding agent (e.g., a synthetic resin bonding agent). The present disclosure is not restricted or limited by the type and properties of the bonding agent that forms the bonding layer.

The bonding layer 500 may be provided in various ways in accordance with required conditions and design specifications.

For example, the bonding layer 500 may be provided by providing a bonding agent application space in the gap between the liner neck part 300 and the boss 200 (e.g., manufacturing the liner neck part by injection molding and then removing a part of the liner neck part corresponding to the gap between the liner neck part and the boss) and then applying the bonding agent into the application space.

Alternatively, before the liner neck part 300 is manufactured by injection molding, the bonding layer 500 may be provided first by applying the bonding agent onto the inner surface of the boss 200 (the inner surface of the accommodation groove of the boss in which the liner neck part is accommodated) Then the liner neck part 300 may be manufactured by injection molding to cover the bonding layer 500.

According to an embodiment of the present disclosure described above, it is possible to obtain an advantageous effect of improving the sealing performance, safety, and reliability.

In particular, according to an embodiment of the present disclosure, it is possible to obtain an advantageous effect of minimizing a leak of hydrogen through the gap between the boss and the liner.

Among other things, according to an embodiment of the present disclosure, it is possible to obtain an advantageous effect of effectively sealing the gap between the boss and the liner by the triple sealing structure.

In addition, according to an embodiment of the present disclosure, it is possible to obtain an advantageous effect of simplifying the structure and the manufacturing process and reducing the costs.

In addition, according to an embodiment of the present disclosure, it is possible to obtain an advantageous effect of reducing a risk of a leak of hydrogen, improving the durability, and extending the lifespan.

While various embodiments have been described above, the embodiments are just illustrative and not intended to limit the present disclosure. It can be appreciated by those having ordinary skill in the art that various modifications and applications, which are not described above, may be made to the present embodiments without departing from the intrinsic features of the present embodiments. For example, the respective constituent elements specifically described in the embodiments may be modified and then carried out. Further, it should be interpreted that the differences related to the modifications and applications are included in the scope of the present disclosure defined by the appended claims.

What is claimed is:

1. A pressure vessel comprising:
a liner configured to store a target fluid;
a boss provided at an end of the liner;
a liner neck part including a first neck portion bent from and connected to the end of the liner and configured to define a first sealing surface provided to contact the boss, a second neck portion bent from and connected to an end of the first neck portion and configured to define a second sealing surface provided to contact the boss, and a third neck portion bent from and connected to an end of the second neck portion and configured to define a third sealing surface provided to contact the boss; and
a pressing part configured to press the first neck portion, the second neck portion, and the third neck portion against the boss.

2. The pressure vessel of claim 1, wherein the liner neck part comprises:
a first contact surface provided on the first neck portion;
a second contact surface provided on the second neck portion; and
a third contact surface provided on the third neck portion,
wherein the pressing part is configured to press the first contact surface, the second contact surface, and the third contact surface.

3. The pressure vessel of claim 2, wherein the first contact surface, the second contact surface, and the third contact surface collectively define a wedge groove having a cross-sectional area gradually decreasing from one end adjacent to the pressing part toward the other end.

4. The pressure vessel of claim 2, wherein the pressing part comprises:
a fastening member fastened to the boss and configured to be movable in a direction toward or away from the second contact surface; and
a pressing block provided at one end of the fastening member facing the second contact surface, and configured to press the first contact surface, the second contact surface, and the third contact surface based on a fastening force applied by the fastening member.

5. The pressure vessel of claim 4, wherein the pressing block has a cross-sectional area gradually increasing from one end adjacent to the second contact surface toward the other end.

6. The pressure vessel of claim 4, wherein the pressing block comprises:
a first block portion configured to press the second contact surface; and
a second block portion provided at an end of the first block portion such that the second block portion has a larger cross-sectional area than the first block portion and configured to press the first contact surface and the third contact surface.

7. The pressure vessel of claim 4, further comprising:
a first screw fastening portion provided on an outer peripheral surface of the fastening member; and
a second screw fastening portion provided on the boss and configured to engage with the first screw fastening portion,
wherein the pressing block is configured to rectilinearly move in the direction toward or away from the second contact surface based on a rotation of the fastening member relative to the boss.

8. The pressure vessel of claim 4, further comprising:
a pressure application groove provided in the fastening member such that the pressure application groove is exposed to the target fluid and configured to allow pressure applied by the target fluid to be applied to the pressure application groove.

9. The pressure vessel of claim 8, further comprising:
a through-hole connected to the pressure application groove and provided in the fastening member such that the pressing block is exposed,
wherein the pressure applied by the target fluid is applied to the pressing block through the through-hole.

10. The pressure vessel of claim 4, wherein the boss comprises a guide surface configured to face the first neck portion and guide an inner peripheral surface of the pressing block between the third neck portion and the fastening member.

11. The pressure vessel of claim 4, further comprising:
a support protrusion provided at an end of the fastening member such that the support protrusion faces an inner surface of the liner.

12. The pressure vessel of claim 1, further comprising:
a first concave-convex pattern provided on at least any one of the first sealing surface and the third sealing surface; and
a second concave-convex pattern provided on the boss and corresponding to the first concave-convex pattern.

13. The pressure vessel of claim 1, wherein the first sealing surface, the second sealing surface, and the third sealing surface are continuously connected along a periphery of the liner neck part.

14. The pressure vessel of claim 1, wherein the boss has higher strength than the liner neck part.

15. The pressure vessel of claim 1, wherein the first neck portion is provided in a longitudinal direction of the liner, the second neck portion is provided in a radial direction of the liner, and the third neck portion is provided in the longitudinal direction of the liner.

16. The pressure vessel of claim 1, further comprising:
a surface treatment layer having micro-voids provided on a surface thereof, the surface treatment layer being provided on an inner surface of the boss corresponding to at least any one of the first sealing surface, the second sealing surface, and the third sealing surface.

17. The pressure vessel of claim 16, comprising:
a micro-void filling layer integrally connected to the liner neck part and configured to fill the micro-voids.

18. The pressure vessel of claim 1, comprising:
a bonding layer provided on an inner surface of the boss corresponding to at least any one of the first sealing surface, the second sealing surface, and the third sealing surface.
